(19) United States
(12) Patent Application Publication
(10) Pub. No.: US 2015/0247964 A1
(43) Pub. Date: Sep. 3, 2015

(54) LIGHT SOURCE DEVICE AND DISPLAY DEVICE EQUIPPED WITH SAME

(71) Applicant: SHARP KABUSHIKI KAISHA, Osaka (JP)

(72) Inventor: Kentaro Kamada, Osaka (JP)

(73) Assignee: Sharp Kabushiki Kaisha, Osaka (JP)

(21) Appl. No.: 14/431,043

(22) PCT Filed: Sep. 27, 2013
(86) PCT No.: PCT/JP2013/076188

§ 371 Date: Mar. 25, 2015

(30) Foreign Application Priority Data
Oct. 3, 2012 (JP) 2012-221021

(51) Int. Cl. F21V 8/00

(52) U.S. Cl. CPC G02B 6/0043; G02B 6/0068; G02B 6/0085

(57) ABSTRACT

A light source includes: a light guide plate having one principal surface on which light scattering elements are provided; at least one first light source unit which causes light from a first end face of the light guide plate to enter the light guide plate; and at least one second light source unit which causes light from a second end face of the light guide plate to enter the light guide plate. When viewed along a mutually opposing direction in which the first end face and the second end face oppose each other, the first light source unit and the second light source unit are arranged with the light emitting areas shifted from each other, and the light scattering patterns formed by the light scattering elements includes a plurality of types of patterns arranged in accordance with the positions of the light emitting areas of the first light source unit and the second light source unit.

### TECHNICAL FIELD

The present invention relates to a light source device, and particularly relates to a light source device that is equipped with a light guide plate and emits planar light. Furthermore, the present invention relates to a display device equipped with the light source device.

### BACKGROUND ART

A liquid crystal display device is a known example of a display device that displays images. Besides a liquid crystal panel, a liquid crystal display device is equipped with a light source device that illuminates the liquid crystal panel from the back surface thereof (referred to as a backlight device). Among such light source devices, there is a type referred to as a direct-lit type and a type referred to as an edge-lit type (side-lit).

For example, as disclosed in Patent Document 1, a light source device of the edge-lit type is equipped with a light source and a light guide plate disposed so that light from the light source enters from an end face of the light guide plate. Based on Snell's Law, after light is emitted from the light source and enters the light guide plate, light with angle elements of at least the critical angle repeatedly undergoes total reflection within the light guide plate, and light with angle elements less than the critical angle exits the light guide plate. Light scattering elements which cause diffusion of light (light scattering dots, unevenness, etc.) are formed on the back side of a light-exiting surface (the surface on the side of the light source device where light is caused to exit) of the light guide plate. This makes it possible for the light that repeatedly undergoes total reflection within the light guide plate to evenly exit outside from the light-exiting surface as planar light.

### RELATED ART DOCUMENT

### Patent Document

Patent Document 1: Japanese Patent Application Laid-Open Publication No. 2002-208307

### SUMMARY OF THE INVENTION

### Problems to be Solved by the Invention

Here, a light source device that is the edge-lit type is normally equipped with a heat dissipation member such as a heat spreader, and heat generated from a light source (LED, for example (Light Emitting Diode), etc.) is dissipated by the heat dissipation member. However, because a large amount of heat is generated by the light source, the temperature of a liquid crystal display device (liquid crystal television) with the light source device built into it can rise easily. From the perspective of quality retention and improved reliability of liquid crystal televisions, it is not preferable for the temperature of a liquid crystal television to rise excessively, and a magnitude of power inputted to the light source (LED, for example) is limited by a temperature that is acceptable to the liquid crystal television itself.

If the light source is composed of LEDs, for example, the amount of heat can be controlled by reducing the number of LEDs, so it is desirable to increase the input power of each LED. In other words, there is potential to reduce cost by reducing the number of LEDs, while maintaining the brightness (luminance) of the display screen of the television. However, if the number of LEDs is simply reduced, a problem arises in which a pitch of the LEDs disposed along the end face of the light guide plate widens, resulting in an unevenness of the light (uneven brightness) emitted from the light source device to the surface.

In view of these points, the purpose of the present invention is to reduce cost while providing a light source device that can ensure the appropriate amount of heat and brightness. Also, another purpose of the present invention is to provide a display device with excellent quality and reliability at a low cost by providing such a light source device.

### Means for Solving the Problems

To achieve the purposes above, a light source device of the present invention includes: a light guide plate having light scattering elements on one principal surface of two principal surfaces opposite to each other; at least one first light source unit that emits light into the light guide plate through a first end face of the light guide plate; and at least one second light source unit that emits light into the light guide plate through a second end face of the light guide plate, the second end face being opposite to the first end face, wherein, when viewed along a mutually opposing direction in which the first light source unit and the second light source unit face each other, a light emitting area of the first light source unit and a light emitting area of the second light source unit are offset from each other, and wherein the light scattering elements on the light guide plate form a plurality of different kinds of light scattering patterns that are arranged in accordance with respective positions of the light emitting area of the first light source unit and the light emitting area of the second light source unit (first configuration). Also, of the two principal surfaces, it is preferable that a principal surface other than a surface provided with the light emitting elements be the light-exiting surface. By separating the light-exiting surface and the surface provided with the light emitting elements, the light emitting efficiency is improved while making it difficult to mistake the front or back of the light guide plate.

According to the present configuration, because a number of light source units arranged to face the end face of the light guide plate can be less than a conventional configuration, it becomes possible to reduce cost while increasing drive power of the light source unit, which was restricted based on the amount of generated heat. Moreover, in the present configuration, a light scattering pattern provided on the light guide plate has a plurality of types in accordance with the reduction of the number of light source units (light emitting areas). Because of this, a light source device can be achieved in which the appropriate amount of heat and brightness is ensured while the cost is reduced.

In the above-mentioned light source device of the first configuration, when viewed in the mutually opposing direction, the light emitting area of the first light source unit and the light emitting area of the second light source unit may be arranged so as not to overlap (second configuration), or, when viewed in the mutually opposing direction, the light emitting area of the first light source unit and the light emitting area of the second light source unit may partially overlap (third configuration). When either of the configurations is used, it is preferable for patterns of the plurality of types to be configured so that a boundary between the neighboring patterns is not noticeable. As a configuration that makes the boundary unnoticeable, a configuration may be used in which each pattern is provided with a gradation area that changes a density of the light scattering elements in stages towards the neighboring pattern, at a vicinity of the boundary of the neighboring patterns.

It is preferable for the light source device according to any one of the first to third configurations to be configured such that the plurality of different kinds of the light scattering patterns are disposed uniformly throughout (fourth configuration). According to the configuration, it is easy to appropriately adjust the brightness of the light emitted to the surface, and also, it is easy to share components between the first light source unit and the second light source unit.

It is preferable for the light source device according to any one of the first to fourth configurations to be configured such that the first light source unit and the second light source unit be attached to heat dissipation member (fifth configuration). According to the configuration, the possibility for the light source device to deteriorate or be damaged by heat can be controlled. Also, the heat dissipation member may be provided by the light source device, or it may be such as an appearance part of a device built into the light source device (liquid crystal display device, etc.), for example.

The light source device according to any one of the first to fifth configurations may be configured such that the first light source unit and the second light source unit are each a light emitting element substrate on which a plurality of light emitting elements are disposed in parallel (sixth configuration). The light source device may be configured such that the light emitting elements are light emitting diodes (seventh configuration).

In order to achieve the objective, a display device of the present invention includes: a light source device according to any one of the first to seventh configurations; and a display panel that is illuminated by the light source device (eighth configuration). Because the display device is a configuration provided with a light source device that can ensure an appropriate amount of heat and brightness, the configuration is excellent for quality and reliability. Furthermore, because the light source device can be achieved at a low cost, the display device of the configuration can also be low cost.

A configuration may be used in which the display panel of the eighth configuration is a liquid crystal panel (ninth configuration).

### Effects of the Invention

Based on the present invention, a light source device can be provided in which the appropriate amount of heat and brightness is ensured while reducing cost. Furthermore, based on the present invention, a display device with excellent quality and reliability can be provided at a low cost by providing such a light source device.

### BRIEF DESCRIPTION OF THE DRAWINGS

FIG. 1 is a schematic top view of the light source device according to Embodiment 1 of the present invention.

FIG. 2 is a schematic cross-sectional view of the light source device cut in the A-A location of FIG. 1.

FIG. 3A is a schematic diagram to describe the light scattering patterns provided in the light guide plate provided by the light source device of Embodiment 1.

FIG. 3B is a pattern diagram to describe the light scattering patterns provided in the light guide plate equipped by the light source device of Embodiment 1 and is a diagram that shows a comparison example.

FIG. 4 is a pattern diagram from the top view of the light source device according to Embodiment 2 of the present invention.

FIG. 5 is a pattern diagram from the top view of the light source device according to Embodiment 3 of the present invention.

FIG. 6 is a pattern diagram from the top view of the light source device according to Embodiment 4 of the present invention.

FIG. 7 is a pattern diagram to describe a modification example of the light source device according to Embodiment 4 of the present invention.

FIG. 8 is a top view to describe the schematic structure of the liquid crystal display device according to the embodiment of the present invention.

FIG. 9 is a schematic cross-sectional view of the liquid crystal display device when it is cut along the B-B location in FIG. 8.

### DETAILED DESCRIPTION OF EMBODIMENTS

The light source device and the embodiment of the display device of the present invention will be described below with reference to drawings.

### Embodiment 1

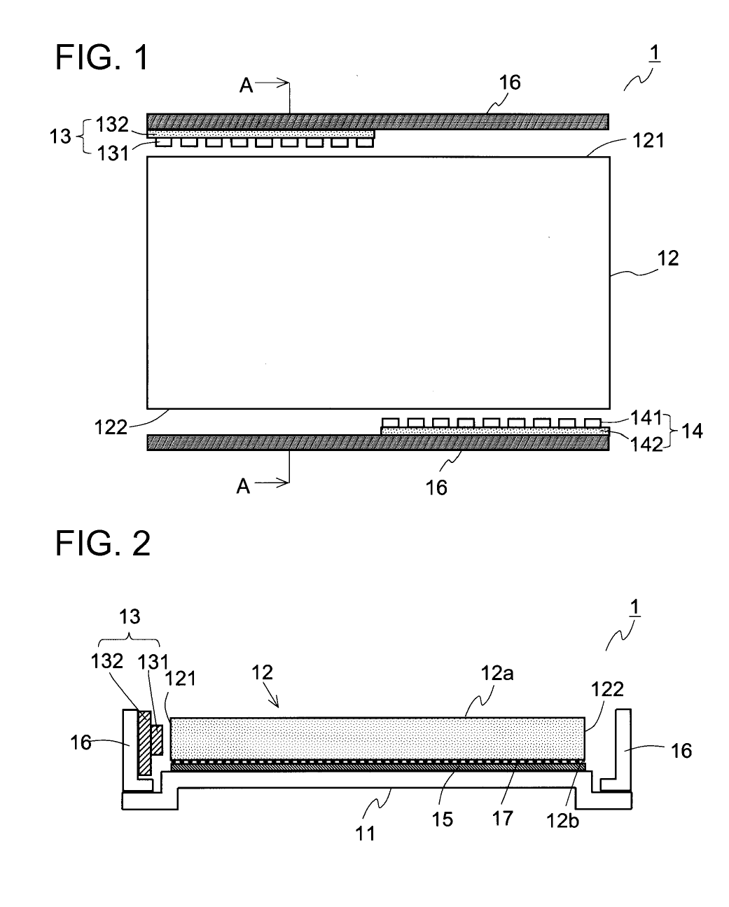

FIG. 1 is a schematic top view of a light source device 1 according to Embodiment 1 of the present invention. FIG. 2 is a schematic cross-sectional view of the light source device 1 when cut along the A-A location in FIG. 1. As FIG. 1 and FIG. 2 show, the light source device 1 is equipped with a chassis 11 obtained by processing sheet metal, for example. A light guide plate 12, a first light source unit 13, a second light source unit 14, a reflection sheet 15, and a heat spreader 16 are installed on the chassis 11.

The light guide plate 12 is a flat plate member of a substantially rectangular shape from the top view, and is formed by resin such as polymethyl methacrylate (PMMA), for example. Of two end faces 121 and 122, which are parallel in the lengthwise direction of the light guide plate 12, an end face 121 (henceforth referred to as the first end face 121) is faced by one first light source unit 13. Also, another end face 122 (henceforth referred to as the second end face 122) is faced by one second light source unit 14.

The first light source unit 13 is provided with a plurality of light emitting elements 131 and a light emitting element substrate 132 mounted with the plurality of light emitting elements 131 arranged thereon in a row at prescribed intervals. The second light source unit 14 is provided with a plurality of light emitting elements 141 and a light emitting element substrate 142 mounted with the plurality of light emitting elements 141 thereon arranged in a row at prescribed intervals, similar to the first light source unit 13. The first light source unit 13 and the second light source unit 14 are provided with the same number of light emitting elements. Because of this, the first light emitting unit 13 and the second light emitting unit 14 may be shared parts.

Also, a light emitting diode (LED: Light Emitting Diode), for example, is suitable to use for the light emitting elements 131 and 141, but other light emitting elements may be used. A known printed circuit board can be used for the light emitting element substrate 132 and 142, which may be a flexible substrate such as FPC (Flexible Printed Circuit), for example, or a rigid substrate may be used.

When viewed along a mutually opposing direction (a vertical direction in FIG. 1 and a lateral direction in FIG. 2) in which the first end face 121 and the second end face 122 face each other, the first light source unit 13 and the second light source unit 14 are arranged shifted from each other. More specifically, when viewed along the mutually opposing direction, the first light source unit 13 and the second light source unit 14 are arranged so as not to overlap. Also, when viewed along the mutually opposing direction, the first light source unit 13 and the second light source unit 14 should be arranged only so that the light emitting areas of the first light source unit 13 and the light emitting areas of the light source unit 14 do not overlap parallel to the lengthwise direction of the first and the second end face 121 and 122. The substrates 132 and 142, which form a portion of each light source unit 13 and 14, may partially overlap.

Light emitted from the first light source unit 13 enters the light guide plate 12 from the first end face 121. Also, light emitted from the second light source unit 14 enters the light guide plate 12 from the second end face 122. Of light that enters the light guide plate 12, light that has angle elements of at least the critical angle is propagated in the light guide plate 12 while being totally reflected.

Of the principal surfaces 12a and 12b of the light guide plate 12 which oppose each other, the principal surface 12b (the bottom surface of FIG. 2) is provided with a light scattering element 17 to evenly eject light that repeatedly undergoes total reflection in the light guide plate 12 from the other principal surface 12a (light-exiting surface 12a; the top surface of FIG. 2). An example of the light scattering element 17 is a diffusion dot obtained by printing ink with a larger refractive index than the material that forms the light guide plate 12. Also, forming fine unevenness or lens shapes on the principal surface 12b, or the like, is another example of the light scattering element 17.

Also, the light scattering pattern formed by the light scattering element 17 of the present embodiment is configured to include two types of patterns, which are split configurations according to the locations of the light emitting areas of the first light source unit 13 and the second light source unit 14. Details about this point will follow.

The reflection sheet 15 is disposed to face a principal surface 12b on the side of the light guide plate 12 provided with the light scattering elements 17. This reflection sheet 15 reflects the light emitted from the light guide plate 12 to outside, and has the role of returning it to the light guide plate 12. By providing the reflection sheet 15, it is possible to increase the efficiency of utilization.

The heat spreader 16 is formed by a member with high heat dissipation (heat dissipation member) and has the role of dissipating the heat generated from the first light source unit 13 and the second light source unit 14. In the present embodiment, the first light source unit 13 and the second light source unit 14 are each fixed in their positions while abutting the heat spreader 16. Also, the heat spreader 16 may be configured to be attached to the chassis 11 as a separate member from the chassis 11, or may be configured to be formed integrally with the chassis 11. Also, in some cases, the heat spreader 16 may form a part of the exterior of devices (liquid crystal display devices, etc.) built into the light source device 1, for example.

Otherwise, an optical sheet which prepares the light emitted from the light guide plate 12 may be disposed on the light-exiting surface 12a of the light guide plate 12 for the light source device 1. Some examples of an optical sheet are diffusion sheets and prism sheets etc., for example, and the number and types of optical sheets may be selected as appropriate. One optical sheet or a plurality of optical sheets (which may be different types) may be disposed.

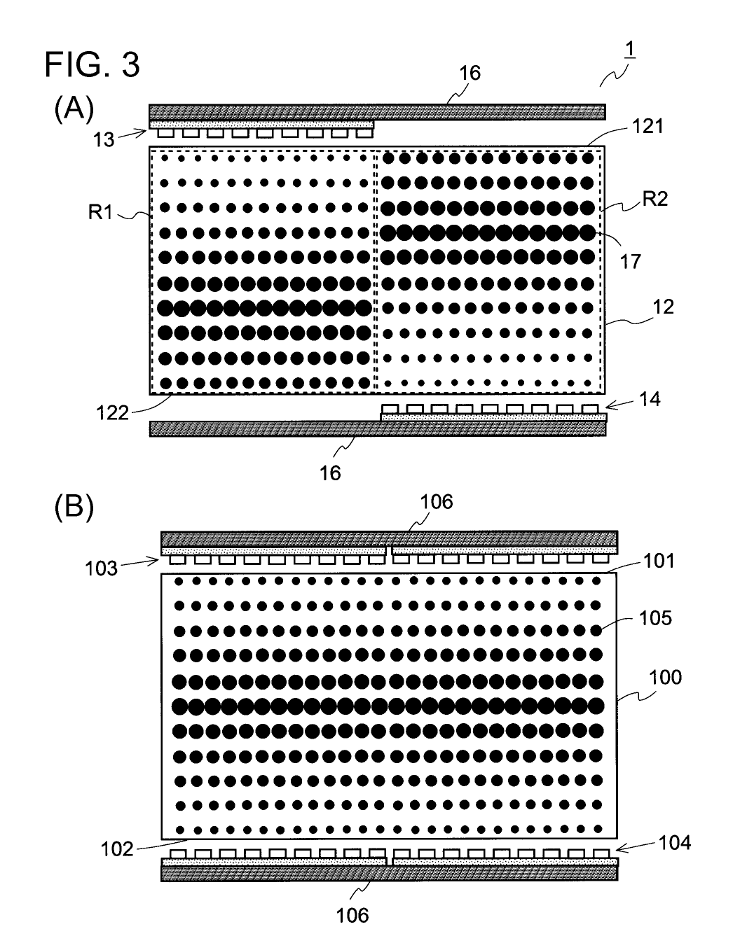

FIG. 3A and FIG. 3B are schematic diagrams to describe the light scattering patterns provided on the light guide plate 12 equipped on the light source device 1 of Embodiment 1. FIG. 3A is a drawing that shows the configuration of the present embodiment and FIG. 3B is a drawing that shows the conventional configuration (drawing as a comparison example). Also, FIG. 3A and FIG. 3B are drawings that assume the light guide plate when it is seen from the side of the light-exiting surface (top surface), and the light scattering pattern formed by the light scattering elements are provided on the surface (bottom surface) facing the light-exiting surface. It should be noted that the light scattering patterns shown in FIG. 3A and FIG. 3B are only shown as examples, and it is obvious that the light scattering patterns provided on the light guide plate may be modified as needed.

As FIG. 3A shows, the light scattering pattern formed by the light scattering elements 17 (here, light scattering dots are illustrated) of the light source device 1 according to the present embodiment are differing patterns between a first area R1 provided according to the first light source unit 13 and a second area R2 provided according to the second light source unit 14. Also the first area R1 and the second area R2 assume a substantially rectangular shape surrounded by dotted lines, and the area of the two areas R1 and R2 are configured to be the same. In other words, the first area R1 and the second area R2 are evenly disposed on the principal surface 12b provided with the light scattering elements 17 of the light guide plate 12.

The light scattering pattern provided in the first area R1 is a pattern which assumes light entering the light guide plate 12 only from the side of the first end face 121. Namely, as a schematic configuration the light scattering dots 17 are sparsely provided near the first end face 121 close to the first light source unit 13, and the light scattering dots 17 are densely provided in the location away from the first end face 121. Also, the light scattering pattern provided on the second area R2 is a pattern which assumes light entering the light guide plate 12 only from the side of the second end face 122. Namely, as a schematic configuration, the light scattering dots 17 are sparsely provided near the second end face 122 near the second light source unit 14, and the light scattering dots 17 are densely provided in the location away from the second end face 122.

Also, the light scattering pattern provided on the first area R1 and the light scattering pattern provided on the second area R2 are configured in the present embodiment so that if one is rotated 180°, it is the same pattern. However, the light scattering pattern provided on area R1 and R2 are not limited to this configuration, and a configuration differing from the present embodiment may be used if a brightness distribution should be intentionally applied to planar light emitted from the light distribution surface 12a, for example.

Conventionally (see FIG. 3B), if light enters the light guide plate 100 from two end faces 101 and 102, which face each other, the first light source unit 103 (there are two in this example) disposed along the first end face 101 and a second light source 104 disposed along the second end face 102 (there are two in this example) are disposed in linear symmetry with the light guide plate 100 therebetween. Because of this, there is only one type of pattern that assumes light entering from the two end faces 101 and 102 as a light scattering pattern formed by the light scattering element 105 (light scattering dots, for example). An example of a light scattering pattern in this case is one in which the light scattering dots 105 are formed sparsely near the end face 101 and 102 (the vicinity of light source units 103 and 104), and the light scattering dots 105 are formed densely towards the center of the mutually opposing direction of the two end faces 101 and 102. Also, reference character 106 is a heat spreader.

The light source device 1 of the present embodiment (see FIG. 3A) has fewer light source units (substrate with a plurality of LEDs installed; LED substrate) compared to the conventional configuration (see FIG. 3B) and an area of the heat spreader of the LED substrate area can be increased. Therefore, if the light source units 13 and 14 are driven under the same conditions for the light source device 1 of the present embodiment, the generated heat associated with driving light source units 13 and 14 is curbed compared to the conventional configuration. As a result, because there is a larger margin for the amount of generated heat, it is easier to increase the power inputted into the LEDs 131 and 141. Therefore, the light source device 1 of the present embodiment can reduce cost by reducing the number of the light source units 13 and 14, while also ensuring an appropriate amount of heat and brightness (luminance).

Also, the light source device 1 of the present embodiment also has the merit of controlling a localized increase in the amount of generated heat compared to when the two LED substrates 13 and 14 are disposed to face only the first end face 121 or the second end face 122.

### Embodiment 2

Next, the schematic configuration of the light source device according to Embodiment 2 of the present invention is described. The explanation of the light source device of Embodiment 2 omits explanations of configurations which overlap with Embodiment 1 and focuses on configurations differing from Embodiment 1. Also, members that overlap with Embodiment 1 are described with the same reference characters.

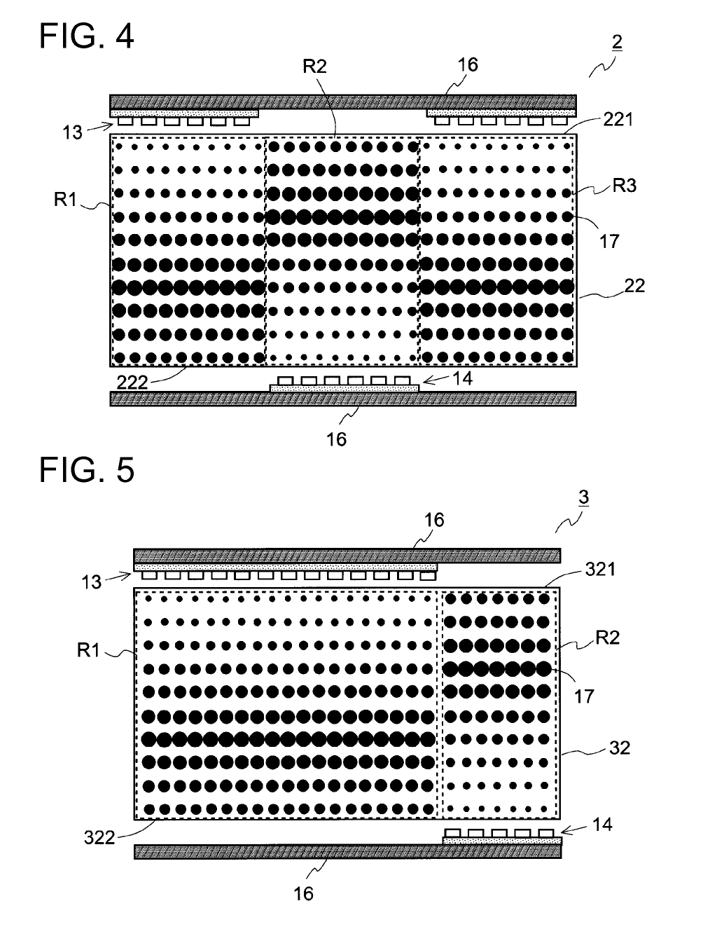

FIG. 4 is a schematic diagram of the light source device 2 according to Embodiment 2 of the present invention when viewed from above. The light scattering pattern provided on the side of the bottom surface (the principal surface opposing the principal surface that is the light-exiting surface) of a light guide plate 22 is also shown in FIG. 4. Also, the light scattering pattern is formed by the light scattering dots 17 (an example of light scattering elements).

As FIG. 4 shows, the two first light source units 13 are disposed to face the first end face 221 of the light guide plate 22 in the light source device 2 of Embodiment 2. The two first light source units 13 are spaced apart from each other and both face the first end face 221 on the end in the lengthwise direction of the first end face 221. Also, one second light source unit 14 is disposed to face the second end face 222 of the light guide plate 22 in the light source device 2.

When viewed along the mutually opposing direction in which the first end face 221 and the second end face 222 face each other (the vertical direction in FIG. 4), the first light source unit 13 and the second light source unit 14 are disposed with the first light source unit 13 and the second light source unit 14 shifted from each other, and the second light source unit 14 is disposed to be interposed between the two first light source units 13. More specifically, when viewed along the mutually opposing direction, the first light source unit 13 and the second light source unit 14 are arranged not to overlap each other. Also, when viewed along the mutually opposing direction, the first light source unit 13 and the second light source unit 14 should be arranged only so that the light emitting area of the first light source unit 13 and the light emitting area of the second light source unit 14 do not overlap in the parallel direction to the lengthwise direction of the first and the second end faces 221 and 222. The substrates 132 and 142, which form a portion of the light source units 13 and 14, may partially overlap.

The light scattering pattern formed by the light scattering dots 17 is a configuration that includes a plurality of types of patterns which are split according to the location of the light emitting areas of the first light source unit 13 and the second light source unit 14. More specifically, the light scattering pattern is a pattern that differs between the first area R1 and a third area R3 provided according to the first light source unit 13 and the second area R2 provided according to the second light source unit 14. Also, the areas R1 to R3 assume areas of a substantially rectangular shape that are surrounded by dotted lines, and are disposed to be interposed between the first area R1 and the third area R3. The area of the three areas R1 to R3 is configured to be the same. In other words, the three areas R1 to R3 are split evenly on the principal surface which is provided with the light scattering elements 17 of the light guide plate 22.

The light scattering patterns provided in the first area R1 and the third area R3 are the same pattern, and are a pattern that assumes light that enters the light guide plate 22 only from the side of the first end face 221. As a schematic configuration, the light scattering dots 17 are sparsely provided near the first end face 221 close to the light source unit 13, and the light scattering dots 17 are densely provided in the location away from the first end face 221 in the light scattering pattern. Also, the light scattering pattern provided in the second area R2 is a pattern that assumes light that enters the light guide plate 22 only from the side of the second end face 222. As a schematic configuration, the light scattering dots 17 are sparsely provided near the second end face 222, which is near the second light source 14, and the light scattering dots 17 are densely provided in the location away from the second end face 222 in the scattering pattern.

The light scattering pattern provided on the first area R1 and the third area R3, and the light scattering pattern provided on the second area R2 are configured in the present embodiment so that if one is rotated 180°, it is the same pattern. However, the configuration is not limited to this and may be configured so that the light scattering pattern formed by the second area R2 does not match the light scattering patterns of the other areas R1 and R3 when it is rotated 180° (a different configuration). In a case such as when the corner area of the light guide plate 22 loses brightness and attempting to fix uneven brightness, the design concept of the light scattering pattern of both ends and the light scattering pattern of the center must be modified, and in such a case a configuration other than the one described is preferable.

The light source device 2 of Embodiment 2 is the preferable configuration when applied to display devices with large screens. The light source device 2 of the present embodiment can also reduce cost by reducing the number of the light source units 13 and 14, while also ensuring an appropriate amount of heat and brightness (luminance).

### Embodiment 3

Next, the schematic configuration of the light source device according to Embodiment 3 of the present invention is described. The description of the light source device of Embodiment 3 omits descriptions of configurations that overlap with Embodiment 1 and focuses on descriptions of configurations that differ from Embodiment 1. Also, members that overlap with Embodiment 1 are described with the same reference characters.

FIG. 5 is a schematic diagram of the light source device 3 according to Embodiment 3 of the present invention when viewed from above. The light scattering pattern provided on the side of the bottom surface (the principal surface facing the principal surface that is the light-exiting surface) of the light guide plate 32 is also shown in FIG. 5. Also, the light scattering pattern is formed by the light scattering dots 17 (an example of the light scattering elements).

As shown in FIG. 5, one first light source unit 13 faces the first end face 321 of the light guide plate 32 in the light source device 3 of Embodiment 3, similar to Embodiment 1, and one second light source unit 14 faces the second end face 322 of the light guide plate 32. Also, similar to Embodiment 1, the light scattering patterns formed by the light scattering dots 17 are different patterns between the first area R1 provided according to the first light source unit 13, and the second area R2 provided according to the second light source unit 14. The light scattering pattern provided by the first area R1 is a pattern that assumes light enters the light guide plate 32 only from the side of the first end face 321, and the light scattering pattern provided by the second area R2 is a pattern that assumes light enters the light guide plate 32 only from the side of the second end face 322.

However, Embodiment 3 differs from the case of Embodiment 1, and the sizes of the first light source unit 13 and the second light source unit 14 differ in the lengthwise direction. Accordingly, the first area R1 and the second area R2 are split unevenly, etc. on the principal surface of the light scattering dots 17 of the light guide plate 32.

The intention of the present invention is to include a configuration like Embodiment 3, and such a configuration can also reduce cost by reducing the number of the light source units 13 and 14, while also ensuring an appropriate amount of heat and brightness (luminance).

### Embodiment 4

Next, the schematic configuration of the light source device according to Embodiment 4 of the present invention is described. The explanation of the light source device of Embodiment 4 omits explanations which overlap with Embodiment 1 and focuses on configurations differing from Embodiment 1. Also, members that overlap with Embodiment 1 are described with the same reference characters.

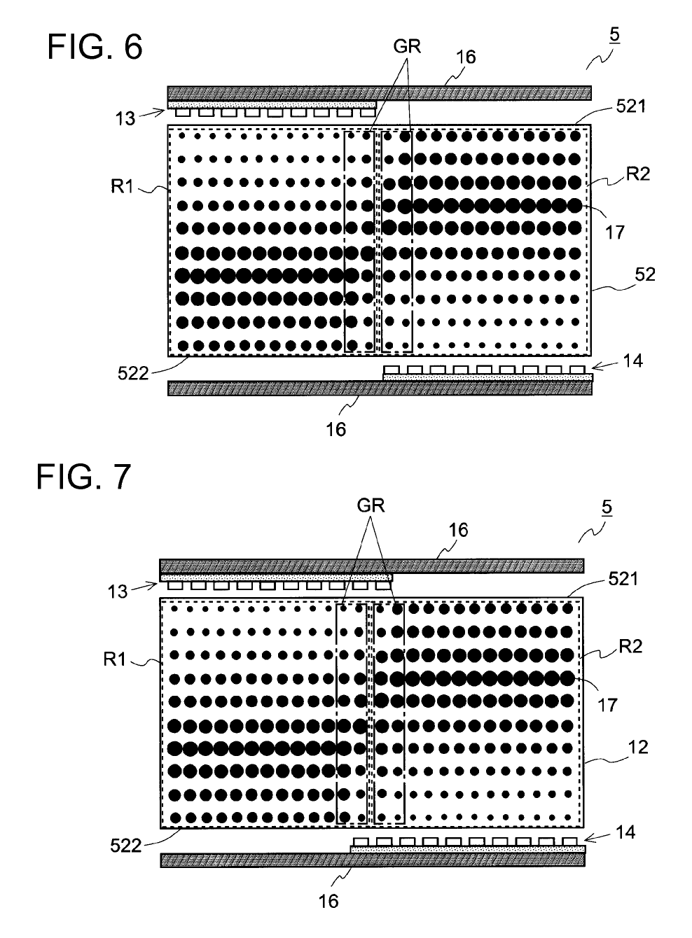

FIG. 6 is a schematic drawing of the light source device 5 according to Embodiment 4 of the present invention when viewed from above. The light scattering pattern provided on the side of the bottom surface (the principal surface facing the principal surface that is the light-exiting surface) of the light guide plate 52 is also shown in FIG. 6. The light scattering pattern is formed by light scattering dots 17 (an example of a light scattering element).

The light source device 5 of Embodiment 4 is provided with a gradation area GR in the first area R1 and the second area R2 of the light guide plate 52. This point differs from the configuration of Embodiment 1. Each gradation area GR is provided near the boundary of the two neighboring areas R1 and R2. Each gradation area GR is configured so that the density of the light scattering dots changes in stages in the direction facing the other area as well.

The gradation area GR is provided with the objective to prevent the boundary of the two areas R1 and R2 from being noticeable when the light source device 5 is in use. Because of this, it is preferable that the gradation area GR provided in areas R1 and R2 have the smallest possible difference in density of the light scattering dots between the two areas R1 and R2, in the vicinity of the boundary location.

Also, the gradation area GR should be provided near the boundary of the two areas R1 and R2, and the configuration of the range and pattern should be determined as needed.

FIG. 7 is a pattern diagram to describe a modification example of the light source device 5 according to Embodiment 4 of the present invention. As FIG. 7 shows, the light emitting area of the first light source unit 13 and the light emitting area of the second light source unit 14 may be configured to partially overlap (locations corresponding to the vicinity of the boundary of the two areas R1 and R2), when viewed along a mutually opposing direction (vertical direction of FIG. 7) in which the first end face 521 and the second end face 522 face each other. By configuring in such a way, an effect can be expected in which the boundary of the two areas R1 and R2 is made to be unnoticeable.

Also, in some cases, the configuration of Embodiment 1 (a configuration that is not provided with a gradation area GR) may also be configured so that the light emitting area of the first light source unit 13 and the light emitting area of the second light source unit 14 partially overlap with the intent for an effect that makes the boundary of the two areas R1 and R2 unnoticeable.

The configuration in which the gradation area is provided and/or the configuration in which the light emitting areas of the two light sources 13 and 14 partially overlap may also be applied to Embodiment 2 or Embodiment 3.

The intention of the present invention includes a configuration similar to Embodiment 4, and such a configuration can also reduce cost by reducing the number of the light source units 13 and 14, while also ensuring an appropriate amount of heat and brightness (luminance).

### Embodiment 5

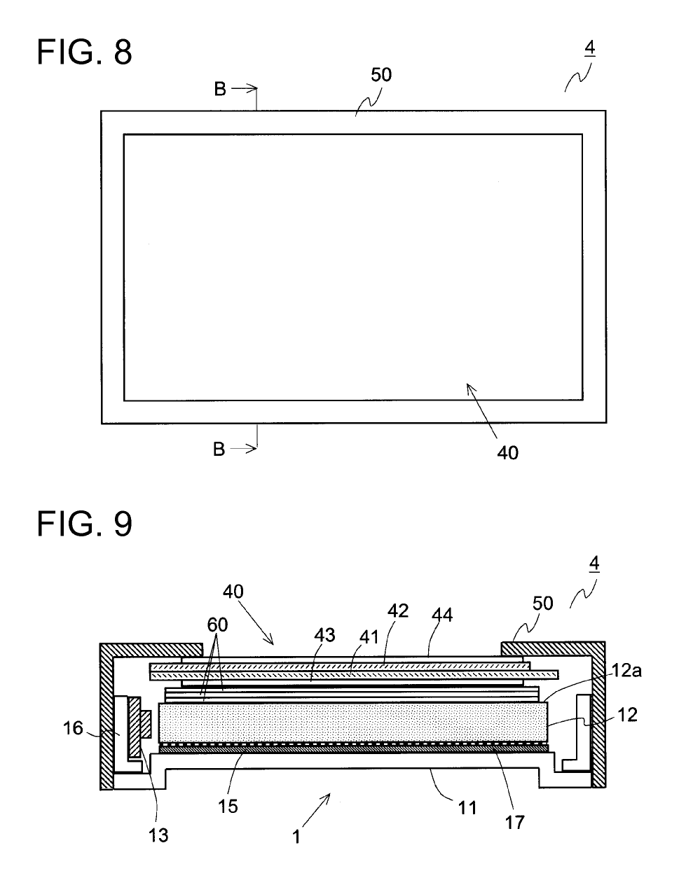

Next, the liquid crystal display device according to one embodiment of the present invention is described. FIG. 8 is a top view to describe the schematic configuration of the liquid crystal display device 4 according to the embodiment of the present invention. FIG. 9 is a schematic cross-sectional view of the liquid crystal display device cut in the B-B direction in FIG. 8. As FIG. 8 and FIG. 9 show, a liquid display device 4 is equipped with a liquid crystal panel 40, and any one of the light sources 1 to 3 and 5, which are shown in the first to Embodiment 4s. Also, the liquid crystal panel 40 and the light source device 1 are connected by a frame-shaped bezel 50 which engages with the chassis 11 (the light soured device 1 may be replaced by the light source device 2, the light source device 3, or the light source device 5. The same applies for below. Also, the reference characters for the components for the light guide plate and the like may be replaced below when the light source device is replaced).

The liquid crystal panel 40 encloses liquid crystal between a pair of a glass substrates 41 and 42 (not shown), which are separate and face each other. Also, a polarizing plate 43 and a polarizing plate 44 are mounted on the bottom surface and the top surface of the liquid crystal panel 40.

Switching elements such as TFTs (Thin Film Transistors) and pixel electrodes connected to such switching elements (both are not shown) are arranged in a plurality in matrices on the surface of the first glass substrate 41. Also, a plurality of scanning signal lines and data signal lines (both are not shown) on the first glass substrate 41 are formed to intersect each other. A counter electrode and color filters (both are not shown) are formed on a second glass substrate 42.

The light source device 1 functions as a backlight device to irradiate light from the back surface of the liquid crystal panel 40. Light emitted from the light-exiting surface 12a of the light guide plate 12 from the first light source unit 13 and the second light source unit 14 passes a plurality of an optical sheets 60 arranged between the light guide plate 12 and the liquid crystal panel 40 and reaches the liquid crystal panel 40. The plurality of optical sheets 60 includes a diffusion sheet and a prism sheet, for example. There are 3 sheets of the optical sheets 60 in the present embodiment, but the number can be modified as needed.

Any one of the light source devices 1 to 3 and 5 according to the embodiment is included in the liquid crystal display device 4. Because of this, it is possible to control a reduction in the quality or reliability of liquid crystal display devices due to heat, and to display a screen with appropriate brightness (luminance). Also, the liquid crystal display device 4 can reduce cost because light source devices 1 to 3 and 5 can be manufactured at a low cost.

### <Other>

Also, the embodiment described above is only an example of the present invention. Namely, the scope of the present invention also includes embodiments with appropriate modifications made to the described embodiments, without exceeding the scope of the technical spirit of the present invention.

The embodiment described above is a configuration that includes the light source units 13 and 14, which includes a plurality of light emitting elements (LED, etc.), for example. However, it is not limited to this and the configuration of the light source units 13 and 14 may include a cold cathode fluorescent tube instead of a plurality of light emitting elements.

Also, the embodiment shown above has one or two light source units that face the first end face of the light guide plate, and has one light source unit that faces the second end face of the light guide plate. The number of the light source units that face the first end face or the second face should be at least one, and the configuration may be changed as needed from the configuration shown above.

Also, the configuration of the embodiment shown above is applied to liquid crystal display devices by the light source device according to the present invention. However, the application range of the light source device of the present invention is not limited to the liquid crystal display device. Therefore, the light source device of the present invention may also be applied to display devices configured with a display panel that uses electro-optic material besides liquid crystal as a light switching material, for example.

### Description of Reference Characters

1, 2, 3, 5 light source device
4 liquid crystal display device
12, 22, 32, 52 light guide plate
12a principal surface serving as light-exiting surface
12b principal surface on which light scattering elements are formed
13 first light source unit
14 second light source unit
16 heat spreader (heat dissipating member)
17 light scattering element
40 liquid crystal panel
121, 221, 321, 521 first end face
122, 222, 322, 522 second end face
131, 141 light emitting element
132, 142 light emitting element substrate

1. A light source device, comprising:
a light guide plate having light scattering elements on one principal surface of two principal surfaces opposite to each other;
at least one first light source unit that emits light into the light guide plate through a first end face of said light guide plate; and
at least one second light source unit that emits light into the light guide plate through a second end face of said light guide plate, said second end face being opposite to said first end face,
wherein a light emitting area of said first light source unit and a light emitting area of said second light source unit are offset from each other in a direction parallel to the first and second end faces in a plan view, and
wherein the light scattering elements on the light guide plate form a plurality of different kinds of light scattering patterns that are arranged in accordance with respective positions of said light emitting area of the first light source unit and said light emitting area of the second light source unit.

2. The light source device according to claim 1, wherein the light emitting area of the first light source unit and the light emitting area of the second light source unit are arranged so as not to overlap in the direction parallel to the first and second end faces in the plan view.

3. The light source device according to claim 1, wherein the light emitting area of the first light source unit and the light emitting area of the second light source unit partially overlap in the direction parallel to the first and second end faces in the plan view.

4. The light source device according to claim 1, wherein said plurality of different kinds of said light scattering patterns are disposed uniformly throughout.

5. The light source device according to claim 1, further comprising:
heat dissipation members,
wherein said first light source unit and said second light source unit are respectively attached to the heat dissipation members.

6. The light source device according to claim 1, wherein said first light source unit and said second light source unit are each a light emitting element substrate on which a plurality of light emitting elements are disposed in parallel.

7. The light source device according to claim 6, wherein said light emitting elements are light emitting diodes.

8. A display device, comprising:
the light source device according to claim 1; and
a display panel that is illuminated by said light source device.

9. The display device according to claim 8, wherein said display panel is a liquid crystal panel.
